(19) United States
(12) Patent Application Publication
(10) Pub. No.: US 2011/0233482 A1
(43) Pub. Date: Sep. 29, 2011

(54) CONDUCTIVE POWDER

(75) Inventors: Tetsuji Honjo, Fukushima (JP); Satoru Kobayashi, Fukushima (JP)

(73) Assignee: Merck Patent Gesellschaft Mit Beschrankter Haftung, Darmstadt (DE)

(21) Appl. No.: 12/671,706

(22) PCT Filed: Aug. 4, 2008
(86) PCT No.: PCT/EP08/06395

§ 371 Date: Feb. 2, 2010

(30) Foreign Application Priority Data
Aug. 8, 2007 (JP) 2007-207276

(51) Int. Cl. H01B 1/08; H01B 1/20; B05D 5/12

(52) U.S. Cl. 252/515; 252/519.34; 252/520.1; 427/108

(57) ABSTRACT

The present invention relates to an electrically conductive powder which has enough transparency for the use in the field of industrial design requiring expressions by colors, in particular, an electrically conductive powder which has superior dispersibility into solvents or polymer matrixes and gives conductivity even with low PWC.

The present invention provides a transparent electrically conductive powder, comprising a first powder component that comprises:(a) a platelet-like aluminum oxide as a first substrate; and (b) a coating layer containing tungsten-doped, or tungsten- and phosphorus-doped, or phosphorus-doped tin oxide wherein the coating layer coats a surface of the first substrate.

The present invention relates to a transparent electrically conductive powder suitable for blending into polymer matrixes in the application of resin compositions, paints and primers to give them electrical conductivity. For more details, the present invention relates to the transparent electrically conductive powder capable of being used for a wide variety of color expression in the field in which design with color is required such as a resin composition, paint or primer.

Electrically conductive powders are used in various fields of applications, for example, antistatic treatment of plastic materials (coating films, films, sheets, molded pieces, etc.), or electrically conductive primers for the electrostatic coating of plastic materials. Carbon blacks have often been used as an electrically conductive powder because of their lower prices. Since, however, carbon blacks have a dark color, their uses are limited in a field where designs with transparency or light colors are required.

From the demand for these colors, antimony-doped tin oxide (hereafter, referred to as “ATO”) is known. However, the toxicity of antimony contained in ATO has been recently concerned, and an electrically conductive powder without antimony is needed. For example, the electrically conductive material containing tungsten-doped tin oxide as a constituent is known (see the patent reference 1 and the patent reference 2).

Since, however, these electrically conductive powders are solely consisted of the particles of tungsten-doped tin oxide, they are not well dispersed in a polymer matrix. Since, in addition, the relative density of tin oxide is high, the number of particles per weight is low, causing a problem that conductivity cannot be increased. To realize a desired conductivity, the powder weight concentration (hereafter, referred to as “PWC”) in a polymer matrix needs to be increased. However, the increase in PWC is not preferred because it leads to the increase in the viscosity of paint and its price. Therefore, the decrease in PWC, i.e. the increase in conductivity per PWC has been demanded.

On the other hand, using white inorganic pigment as a substrate, a composite particle coated with tungsten-doped tin oxide has been also proposed (see the patent reference 3, the patent reference 4). Since, however, these proposals aim at providing white electrically conductive powders, their applications are limited in the field where design using comprehensive color expression is required.

Although, in addition, an electrically conductive powder in which its substrate is coated with tungsten-doped tin oxide has been also disclosed in the patent reference 5, there is no specific description about an alumina flake as a substrate, and an electrically conductive powder which has light color and high transparency is not disclosed.

In addition, phosphorus-doped tin oxide and composite particles coated with phosphorus-doped tin oxide have been also proposed (patent references 4 and 6 to 8).

However, doping solely with phosphorus may cause the problem that the electrical conductivity of the electrically conductive powder decreases with a laps of time when kept in the air.

Moreover, there is also no disclosure in the prior art to use a transparent alumina flake as a substrate.

Patent reference 1: JPA H9-278,445

Patent reference 2: JPA H9-503,739

Patent reference 3: JPA 2002-179,948

Patent reference 4: JPA 2004-349,167

Patent reference 5: DE 10,148,055

Patent reference 6: JPA S60-260,424

Patent reference 7: JPA H6-92,636

Patent reference 8: JPA 2006-172,916

The purpose of the present invention is to provide an electrically conductive powder which has enough transparency for the use in the field in which design with variety of color expression is required. In particular, an electrically conductive powder which has a superior dispersibility into solvents or polymer matrices, gives enough conductivity even with low PWC and has superior long-term stability.

Further, the purpose of the present invention is to provide a novel method for manufacturing the transparent electrically conductive powder bearing the above-mentioned properties.

The present invention is directed to an electrically conductive powder, comprising a first powder component that comprises:
(a) a doped or undoped platelet-like aluminum oxide as a first substrate, and
(b) a coating layer containing at least any one of tungsten-doped tin oxide or phosphorous-doped tin oxide and coating the surface of the first substrate.

According to the present invention, there is provided a transparent electrically conductive powder, which particularly has superior dispersibility into solvents or polymer matrixes, gives enough conductivity even with low PWC and has superior long-term stability. Therefore, in particular, the transparent electrically conductive powder is advantageously used in the field in which design with variety of color expression is needed.

### BRIEF DESCRIPTION OF THE DRAWINGS:

FIG. 1 is a SEM image of the transparent electrically conductive powder produced by the Working Example 5.

FIG. 2 is a SEM image of the transparent electrically conductive powder produced by the Comparative Example 2.

FIG. 3 is a SEM image of the transparent electrically conductive powder produced by the Comparative Example 3.

The transparent electrically conductive powder of the present invention is explained with its manufacturing method below.

The transparent electrically conductive powder of the present invention comprises the first powder component and optionally the second powder component. The first powder component mainly contributes to the increase in transparency and electrical conductivity, and the second powder component is supplementary used to increase conductivity and decrease PWC by the combination with the first powder component.

The first powder component is the powder wherein the platelet-like aluminium oxide acts as a first substrate and is coated on the surface with a coating layer containing tungsten-doped tin oxide, or tungsten- and phosphorous-doped tin oxide, or phosphorous-doped tin oxide.

The platelet-like aluminum oxide, which may be undoped or doped with metal element, used herein as a first substrate generally has heat resistance and acid resistance as well as superior mechanical strength.

In terms of the shape of the platelet-like aluminum oxide, its average particle diameter is preferably 1 to 100 μm, more preferably 5 to 60 μm.

Preferably, its thickness is not more than 1 μm, more preferably 0.05 to 0.5 μm. Preferably, its aspect ratio (=average particle diameter/thickness) is not less than 10, preferably not less than 50.

In particular, a powder having a high aspect ratio and a small thickness tends to contact each other powder, and can provide desired conductivity with low PWC. When, consequently, such powder is blended in a resin matrix, a high-transparent resin can be obtained. However, a powder thickness with 0.05 μm or less in thickness has low mechanical strength, is readily broken, and is not for practical use.

The platelet-like aluminum oxide used in the present invention is preferably doped with a metal element, which is advantageous because the coating layer formed on a surface readily adheres during manufacturing it. The examples of doping metal element include titanium and/or tin. Among them, titanium is preferred. On basis of the weight of oxides, doping metal element preferably exists at 0.1 to 4 wt. % of aluminum oxide (100 wt. %).

A single particle (primary particle) of platelet-like aluminum oxide preferably forms a single crystal. As a result, the first substrate is transparent, and a single particle of the first powder component is also highly transparent. Thus, the transparency of the transparent electrically conductive powder increases. In addition, the refractive index of the first substrate is preferably 2.0 or less, in particular, 1.2 to 1.8. As a result, when it is blended in a resin matrix, a resin composition having higher transparency can be obtained.

In terms of a metal element-doped platelet-like aluminum oxide used as the first substrate, the titanium-doped platelet-like aluminum oxide (i.e., platelet-like aluminum oxide containing titanium oxide) described for example in JP 3,242,561 is specifically exemplified. This titanium-doped platelet-like aluminum oxide has a smooth surface, large aspect ratio (average particle diameter/thickness), and exhibits no twin crystal formation or aggregation, superior dispersibility, and high transparency as a substrate, and meets each property described above. Further, the adherence of the coating layer described below increases, and it is possible to create a uniform coating layer on the substrate.

In addition, tin-doped platelet-like aluminum oxide may be produced by replacing titanium salt with tin salt in the above-mentioned method. Also, it may be done by the method according to JP-A 2005-082,441.

The metal element-doped platelet-like aluminum oxide obtained by these methods or undoped platelet-like aluminum oxide has 2.0 or less of refractive index and is preferably a monocrystal.

As long as the transparency, the feature of the present invention, does not degrade, other platelet-like substrates may be used in combination with the first substrate. These other platelet-like substrates are preferably selected from materials having 2.0 or less in the above-described refractive index, for example, platelet-like silicon dioxide (described for example in JP-A H7-500,366).

Next, the second substrate as the substrate of the second powder component is explained. The second substrate is preferably a material having 2 or less in refractive index, particularly, 1.2 to 1.8, and is preferably selected from silicon dioxide particle, aluminum oxide and the combination thereof. The shape of the second substrate is selected from “non-platelet-like” shapes, and needle-like particles, spherical particles and so on, are exemplified. In the case of needle-like particles, the ratio of its long axis and short axis (i.e., long axis/short axis) ranges from 2 to 100, preferably 10 to 50. In the case of sphere (including oval sphere), the ratio of its long axis and short axis (i.e.; long axis/short axis) ranges from 1 to 10, preferably 1 to 5.

In terms of the size of the particle, average particle diameter is not more than 20 μm, preferably not less than 1 μm and not more than 10 μm. In the case of a needle-like shape, the average diameter of the cross-section perpendicular to a long axis is preferably within this range.

As a representative example of the second substrate, examples of silicon dioxide (silica particle) which are commercially available include for example those available as “FS-3DC” (product name) from Denki Kagaku Kogyo Co., Ltd., “SUNSPHERE NP-30” (product name) from ASAHI GLASS Co., LTD., “SIKLON SF600” (product name) from Quarzwerke GmbH, and “MIN-U-SIL 10” (product name) from U.S. SILICA COMPANY. In addition, examples of aluminum oxide include alumina particle “AT200” from (product name) Nippon Light Metal Co. Ltd.

By the combination use with the second powder component obtained from the second substrate having such shapes, the transparent electrically conductive powder providing conductivity at low PWC as described below.

The transparent electrically conductive powder of the present invention can be obtained by mixing the first powder component and the second powder component after forming the coating layer containing TTO or the coating layer containing TPTO, or the coating layer containing PTO separately, or pre-mixing the first substrate and the second substrate, and then forming the TTO or TPTO or PTO-containing coating layer on the surfaces of both substrates at the same time to give the mixture of the first powder component and the second powder component.

In, for example, the case of mixing the first substrate and the second substrate, and then forming the coating layer on the surfaces of both substrates at the same time, the mixing ratio of the first substrate and the second substrate preferably ranges from 9:1 to 2:8 by weight, more preferably from 8:2 to 5:5.

In the case of individually producing the first powder component and the second powder component from the first substrate and the second substrate, respectively, the mixing ratio of the first powder component and the second powder component of transparent electrically conductive powder of the present invention preferably ranges from 9:1 to 2:8 by weight, more preferably from 8:2 to 5:5.

Next, coating layers and the method for forming them are explained. In the first powder component and the second powder component, coating layers individually coat the first substrate and the second substrate, and contain tungsten-doped tin oxide (TTO) or tungsten- and phosphorus-doped tin oxide (TPTO), or phosphorus-doped tin oxide (PTO).

In the following explanation, the “coating layer” denotes both the coating layer of the first powder component and the coating layer of the second powder component, and the “substrate” denotes both the first substrate and the second substrate unless a specific mentioning. In addition, the “coating layer”, and the “first coating layer” and the “second coating layer” hereafter denote not only the layer existing on the transparent electrically conductive powder in the final product (for example, after calcination) but also the layer occurring during steps of manufacturing (for example, hydrate layer before calcination).

In terms of the coating layer, the tungsten-doped, or tungsten- and phosphorus-doped, or phosphorous-doped tin oxide layer is constituted to exist on at least the top surface of the first and second powder component particles. The coating layer preferably comprises the first coating layer and the second coating layer. The second coating layer is the layer forming the top surface of the first and second powder component particles, and the layer of the tungsten-, or tungsten- and phosphorus-, or phosphorous-doped tin oxide. The first coating layer preferably is a tin oxide layer, whereas it may be the layer of the tungsten-, or tungsten- and phosphorus-, or phosphorous-doped tin oxide.

The ratio of tin and tungsten used in TTO coating layer corresponds to 99.7:0.3 to 80:20 in terms of atomic ratio. Preferably, it is from 99:1 to 90:10. The ratio of tin and tungsten and phosphorus used in TPTO coating layer corresponds to 99.4:0.3:0.3 to 70:10:20 in terms of atomic ratio. Preferably, it is from 98 :1:1 to 85:5:10. The ratio of tin and phosphorous used in PTO coating layer corresponds to 99.7:0.3 to 80:20 in terms of atomic ratio. Preferably, it is from 99:1 to 90:10.

Especially, they may exist with this ratio at or near the top surface of the coating layer. In, therefore, the case of the constitution of the first coating layer and the second coating layer, the second coating layer preferably meets this condition.

Also, the electrical conductivity increases even in the case of calcinations in the air, and superior long-term stability can be realized by doping tungsten and phosphorus (see Table 4).

A coating layer not containing tin oxide, such as silicon dioxide may be formed between the first coating layer and the substrate. In addition, the first coating layer may be a tin oxide layer (one of tungsten-doped, tungsten- and phosphorus-doped, phosphorous-doped and undoped), and the silicon dioxide layer may be formed between the first coating layer and the second coating layer. Further, the silicon dioxide layer may be formed as the first coating layer between the second coating layer and the substrate. Since silicon dioxide has low refractive index, it is effective for transparency.

In the manufacturing method below, an example, in which the tungsten-doped, tungsten- and phosphorus-doped, or phosphorous-doped, or undoped tin oxide layer as the first coating layer is formed, and subsequently to the formation of the first coating layer, the tungsten-doped or tungsten- and phosphorus-doped, or phosphorous-doped, tin oxide layer is formed, is explained as the most preferable embodiment.

First, the substrate is dispersed in water to give a suspension. The pH of this suspension may be arbitrarily set unless the next step to form the first coating layer is prohibited. Usually, the substrate may be just dispersed in water without a specific control of pH.

As the tin compounds used for tin compound solution, tin salts including tin chloride, tin sulfate, tin nitrate and the like; and stannate salts including sodium stannate, potassium stannate, lithium stannate and the like are exemplified.

As the tungsten compounds used for tungsten compound solution, ammonium tungstate, potassium tungstate, sodium tungstate, ammonium meta-tungstate, potassium meta-tungstate, sodium meta-tungstate, ammonium para-tungstate, potassium para-tungstate, sodium para-tungstate, tungsten oxychloride and the like are exemplified.

As the phosphorus compounds used for phosphorus compound solution, orthophosphoric acid, metaphosphoric acid, pyrophosphoric acid, tripolyphosphoric acid, phosphorous acid, hypophosphorous acid and the like are exemplified.

The cases using tin salts and using stannates as a tin compound are separately explained.

(i) In the Case Using Tin Salts:

First, during the step to form the first coating layer, a tin salt aqueous solution is added to the substrate suspension while controlling the pH, preferably at 1.5 to 2.2, to form the first coating layer by the deposition of tin oxide hydrate on the substrate surface. Because of strong acidity of tin salt aqueous solution, the above-mentioned pH is kept by using an alkaline aqueous solution. Although the alkaline aqueous solution is not specifically limited, commonly used alkaline aqueous solutions including sodium hydroxide, potassium hydroxide, ammonia water and the like may be used. More preferably, the pH condition is the range from 1.6 to 2.0. The tin salt aqueous solution and the alkaline aqueous solution are preferably added to the suspension in drop-wise so that the total amount of the source materials is introduced to the coating layer. This is the same for other solutions hereafter.

In order for the first coating layer to be tungsten-doped, or tungsten- and phosphorus-doped, or phosphorous-doped tin oxide layer, a tungsten compound aqueous solution, or a combination of a tungsten compound aqueous solution and a phosphorus compound aqueous solution, or phosphorous compound aqueous solution, is concurrently added in addition to a tin salt aqueous solution while keeping pH within the above condition. In these cases, an alkaline aqueous solution or an alkaline mixture solution of a tungsten compound dissolved in an alkaline aqueous solution may be used in order to keep the pH constant.

During the next step to form the second coating layer, in addition to a tin salt aqueous solution, a tungsten compound aqueous solution or combination of a tungsten compound aqueous solution and a phosphorus compound aqueous solution, or phosphorous compound aqueous solution is added while controlling pH, preferably within the range from 2.2 to 3.5, to give the second coating layer. In this case, an alkaline aqueous solution or an alkaline mixture solution of a tungsten compound dissolved in an alkaline aqueous solution may be used in order to keep the pH constant. The pH for coating preferably ranges from 2.6 to 3.2.

During the first step of coating and the second step of coating, addition (preferably, in drop-wise) is usually carried out while being stirred. Although the temperature may be arbitrarily set, it may be, for example, in the range from room temperature to 100° C., preferably it ranges from 40 to 90° C. By selecting a proper condition, the total amount of added tin component, a tungsten component and, if present, a phosphorus component in source materials can be deposited and attached on the substrate surface.

By controlling the pH of coating as the two step manner as above, a smooth coating layer without crack can be easily obtained. For example, coating in a single range from pH 1.5 to 2.0 tends to cause cracks on the coating layer. This crack occurrence reduces the conductivity and transparency of each powder. Further, when coating is performed in a single range from pH 2.2 to 3.5, deposition of non-coating particles tends to form on the surface of the coating layer, and leads to the lack of smoothness on the coating layer. As the number of this non-coating fine particle increases, fluidity of each powder becomes low, which results in insufficient dispersibility in a resin matrix, and then a desired conductivity cannot be achieved at low PWC.

Thus, the transparent electrically conductive powder without crack can be easily obtained through the formation of the second coating layer after the formation of the first layer.

(ii) In the Case Using Stannate Salts:

First, during the step to form the first coating layer, a stannate salt aqueous solution is added to the substrate suspension while controlling the pH, preferably at 4 to 6, to form the first coating layer by the deposition of tin oxide hydrate on the substrate surface. Because of alkalinity of stannate salt aqueous solution, the above-mentioned pH is kept by using an acidic aqueous solution. Although the acidic aqueous solution is not specifically limited, commonly used acidic aqueous solutions including hydrochloric acid, sulfuric acid, nitric acid, acetic acid and so on may be used. More preferably, the pH for coating is in the range from 4.5 to 5.5. The stannate salt aqueous solution, the acidic aqueous solution are preferably added to the suspension in drop-wise so that the total amount of the source materials are introduced to the coating layer.

In order for the first coating layer to be tungsten-doped or tungsten- and phosphorus-doped, or phosphorous-doped tin oxide layer, a tungsten compound aqueous, or a combination of a tungsten compound aqueous solution and phosphorus compound aqueous solution, or phosphorous compound aqueous solution is concurrently added in addition to a stannate salt aqueous solution while keeping the above-mentioned condition of pH.

During the next step to form the second coating layer, in addition to a stannate salt aqueous solution, a tungsten compound aqueous solution or combination of a tungsten compound aqueous solution and phosphorus compound aqueous solution or phosphorus compound aqueous solution are added while controlling pH, preferably within the range from 2.2 to 3.5, to give the second coating layer. For the adjustment of the pH at this time, an acidic aqueous solution similar to the above description is used. More preferably, the pH for coating ranges from 2.6 to 3.2.

During the first step of coating and the second step of coating, addition (preferably, drop-wise adding) is usually carried out while being stirred. Although the temperature may be arbitrarily set, it may be, for example, in the range from room temperature to 100° C., preferably it ranges from 40 to 90° C. By selecting a proper condition, the total amount of a tin component, a tungsten component and, if present, phosphorus component in source materials can be deposited and attached on the substrate surface.

By controlling the pH of coating as the two step manner like this, a smooth coating layer without deposition of non-coating particles can be easily obtained. For example, coating in a single range from pH 4 to 6 tends to result in increase in pH of powder, which leads to the reduction in the conductivity of each powder (see table 3). Further, when coating is performed in a single range from pH 2.5 to 3.5, deposition of non-coating particles forms on the surface of the coating layer, and tends to lead to the lack of smoothness on the coating layer. As the number of this non-coating fine particle increases, fluidity of each powder becomes low, which results in insufficient dispersibility in a resin matrix, and then a desired conductivity cannot be achieved at low PWC.

In the both cases (i) and (ii), after forming the coating layer, the solid is washed and filtered, dried if needed, and calcinated at 300 to 1.100° C., preferably 700 to 1.000° C. Calcination atmosphere used herein include air, oxygen and inert gas atmosphere such as nitrogen.

The present invention is advantageous in that the calcination in the air is preferably employed because the production cost can be reduced and the electrically conductive powder can be obtained more colorless. Normally it has a trend to be higher conductive in the calcination condition of inert gas atmosphere than air, oxygen. It is desirable to have calcination conditions under inert gas atmosphere. The condition of calcination atmosphere may be appropriately adopted the any one either air, oxygen or inert gas such as nitrogen dependent on the target.

In the transparent electrically conductive powder obtained above, the amount of the coating layer coating the substrate is in the range from 25 to 300 parts by weight as the oxides per the substrate of 100 parts by weight (specifically, in case of that the first coating layer is the tungsten-doped, tungsten- and phosphorus-doped, or phosphorus-doped, or un-doped tin oxide layer and that the second coating layer is the tungsten-doped, or tungsten- and phosphorus-doped, or phosphorus-doped tin oxide layer as a preferable embodiment). Preferably, it ranges from 60 to 150 parts by weight. Higher amount of coating layer than these amounts is not preferable because sufficient transparency cannot be obtained whereas the effect of the increase in conductivity cannot be realized. If, on the other hand, the amount of coating is low, sufficient conductivity cannot be obtained.

Also, in terms of the ratio of the first coating layer and the second coating layer, the added amount of source materials may be adjusted so that the first coating layer:the second coating layer is 5:95 to 60:40 by weight as the oxides. More preferably, it is 10:90 to 45:55. When the first coating layer is un-doped tin oxide layer, it is economical because of smaller amount in using tungsten or phosphorus.

The pH of the transparent electrically conductive powder obtained after calcination depends on the condition during the formation of the second coating layer that is the outermost layer. According to the method stipulated in JIS K5101-17-2, the pH of the powder is determined by suspending the powder in water at room temperature and then measuring the pH of the liquid. The transparent electrically conductive powder of the present invention preferably indicates pH 8 or lower, more preferably within the range from pH 2 to 6. This is because the conductivity seriously decreases when the pH of powder is 8 or higher (see the Table 3 below). Unless the pH of the solution as coating is lower than 4, the powder's pH becomes higher than 8, and the conductivity seriously decreases. Therefore, experiments have revealed the necessity to control the pH lower than 4 (see the Table 3 below).

Among the resultant the first powder component and the second powder component, the first powder component especially has superior transparency. In a preferable embodiment, the first substrate is single crystal and has high transparency, and the first powder component per se is transparent. Since, in addition, the refractive indexes of the powder component and resin matrix in use are almost same, there is little light reflection at their interface as dispersed in a resin matrix, and it is featured by higher transparency. The first powder is characterized in that the film of 8 μm in thickness formed on a PET sheet by a resin containing the powder of 30 wt. % in a powder concentration has preferably 70% or higher of total-optical transmission by the measurement according to JIS K-7361.

As described above, the transparent electrically conductive powder of the present invention preferably contains the second powder component in addition to the first powder component in order to increase conductivity. When the second component is contained, its amount is preferably at the level of detectable effect, for example, the ratio of the first powder component and the second powder component is from 9:1 to 2:8 by weight, preferably 8:2 to 5:5.

As described above, by the transparent electrically conductive powder of the present invention, particularly the first powder component, transparent electrically conductive powders can be obtained. Further, by the combination with the second powder component using needle-like or granular inorganic particles as the second substrate, the platelet-like particles forming the first powder components can easily contact through the second powder components, and it became possible to realize a desired conductivity at low PWC. As a result, the amount to use the electrically conductive powder in a resin matrix can also be reduced, and higher transparent resin compositions can be obtained. Then, the increase in the cost and viscosity of, for example, electrically conductive paints can be lowered due to decrease in a use amount (i.e. concentration). Since, further, the margin of allowing the additional other components in paint increases, flexibility of product-designs in use of electrically conductive powders increases. Thus, the expansion of the purpose for use and application of the electrically conductive powders are realized.

In a typical embodiment of the composition of the present invention comprising the first powder component and the second powder component at PWC of 30% in a resin matrix, surface resistance is not higher than 50 MΩ, preferably not higher than 20 MΩ, and the film of 8 μm in thickness formed on a PET sheet using the same has total-optical transmittance measured by JIS K-7361 of preferably 70% or higher, more preferably 75% or higher.

Further, application examples using the transparent electrically conductive powder of the present invention is explained hereafter. The transparent electrically conductive powder of the present invention can be used in comprehensive field of applications. Examples of applications include resin compositions, primers, concoctions (preparation mixture), paints, lacquer, printing inks, plastics, and films; more specifically, antistatic treatment for plastic materials (coating films, films, sheets, molded products, etc.) or electrically conductive primers in use for electrostatic coating.

These applications are explained in more details below. As an example for using in resin compositions, when the transparent electrically conductive powder of the present invention is incorporated into resin, the powder may be directly mixed with the resin, or forming pellets beforehand and then mixing with the resin to give various molded products by extrusion molding, calendaring, blow molding and so on. Resin component used include any thermoplastic resins such as polyolefin-based resins and any thermosetting resins such as epoxy-based resins, polyester-based resins and polyamide (nylon)-based resins.

Further, the transparent electrically conductive powder of the present invention can be used for especially manufacturing electrically conductive films and plastics, for example, the electrically conductive films and sheets, plastic containers and molded products for any applications needing electrical conductivity which a person skilled in the art knows (for example, including antistatic applications). The plastics suitable for the integration of the electrically conductive pigments of the present invention include any commonly used plastic, for example, thermosetting materials and thermoplastic materials.

Needless to say, the transparent electrically conductive powder of the present invention treated to prevent weld line (for example, encapsulating treatment) may also be used. Further, in the resin compositions of the present invention, the pigments described below may be used in combination with the transparent electrically conductive powders of the present invention.

When the transparent electrically conductive powder of the present invention is used for paints for antistatic coating, organic solvent-based paints, NAD-based, water-based paints, emulsion paints, colloidal paints and powder paints may be exemplified.

These paints may be used for coating of lumbers, plastics, metal steel sheets, glass, ceramics, papers, films, sheets, the translucent membranes for reflector of LC display and the like.

As the applications of paints, use for automobiles, for constructions, for ships, for electronics, for cans, for industrial equipments, for road marking, for plastics and for household use and the like may be exemplified.

Method for coating includes, but not limited to, spray coating, electrostatic coating, electro-deposition coating and the like.

Regarding the structures of painted film, examples include, but not limited to, a structure having the order of a foundation layer, an intermediate coat layer, a layer containing the transparent electrically conductive powder of the present invention and a clear layer, or a structure having the order of a foundation layer, an intermediate coat layer containing the transparent electrically conductive powder of the present invention and a clear layer. Furthermore, for the paints of the present invention, the following pigments may be used in combination with the transparent electrically conductive powder of the present invention.

As the examples of using the primers, a resin mixed with at least one of modified resin selected from the group consisting of polyolefin resin, acrylic resin, polyester resin and polyurethane resin, and a water-based paint or organic solvent-based paint containing a cross-linker may be utilized.

Water-based primers typically contain binder components. The binder components are not restricted as long as they have enough hydrophilic groups for solubility or dispersion in water. In addition, the primers may contain other additives including antifoaming agent, thickener, surfactant, etc.

Articles to be coated with the above-mentioned primers are not limited, and for example, interior and exterior automotive trims, outer panel parts of interior and exterior housing trims and home electric appliances and so on are exemplified. Further, the substrates of the above-mentioned coated products are not specifically restricted, and include metal boards, resin boards, glass boards, ceramic board and the like, and specific example of resin boards include those from polyolefin resin, polycarbonate resin, ABS resin, urethane resin, nylon, polyphenylene oxide resin and the like. If needed, the above-mentioned substrate may be treated with degreasing, water washing.

The primers containing the transparent electrically conductive powder of the present invention provides electrically conductive with high transparency, and hardly affect the coloring of paints to be coated thereon. Further, they impart electrical conductivity to various non-conductive materials and enable to perform electrostatic coating thereon. Therefore, they can be used as the electrically conductive primers for electrostatic coating. Their coating method includes electrostatic coating, electro-deposition coating, spray coating and so on, but it is not limited. Furthermore, for the primers of the present invention, the pigments described below may be used in combination with the transparent electrically conductive powders of the present invention.

As application use for ink, plastic, rubber and other prepared mixtures, the transparent electrically conductive powder of the present invention is particularly suitable for prepared mixtures intending electrical conductivity, and may be combined with any types of generally-used materials and auxiliaries. Specifically, they may be used for printing ink (printing ink for gravure, offset, screen and flexographic printing), toner for copy machines, laser marking, cosmetic preparations and so on. Furthermore, for the ink, plastic and rubber and other prepared mixtures, the pigments described below may be used in combination with the transparent electrically conductive powder of the present invention.

The examples for the pigments that may be used in combination with the transparent electrically conductive powder of the present invention in the above-mentioned resin compositions, paints, lacquer, primers and prepared mixtures are exemplified below. The examples include titanium dioxide, calcium carbonate, clay, talc, barium sulfate, white carbon, chromium oxide, zinc oxide, zinc sulfide, zinc powder, metal powder pigment, iron black, yellow iron oxide, colcothar, chrome yellow, carbon black, molybdate orange, iron blue, ultramarine blue, cadmium-based pigment, fluorescent pigment, soluble azo pigment, insoluble azo pigment, condensation-type azo pigment, phthalocyanine pigment, condensation polycyclic pigment, composited oxide pigment, graphite, mica (for example, moscovite, brown mica, synthetic mica, fluorine four silicon mica and so on), metal oxide coating mica (for example, titanium oxide coating mica, titanium dioxide coating mica, (hydration) iron oxide coating mica, iron oxide and titanium oxide coating mica, lower-oxidation number titanium oxide coating mica and so on), metal oxide coating graphite (for example, titanium dioxide coating graphite and so on), platelet-like alumina, metal oxide coating alumina (for example, titanium dioxide coating alumina, iron oxide coating platelet-like alumina, ferric trioxide platelet-like alumina, triiron tetroxide platelet-like alumina, interference color metal oxide coating platelet-like alumina and so on), MIO, metal oxide coating MIO, metal oxide coating silica flake, and metal oxide coating glass flake.

Also, the powder surfaces of the transparent electrically conductive powder of the present invention and the pigments that may be used with the powder may be treated, directly or indirectly, with silane coupling agents or titanium coupling agents in order to improve their dispersibility. Further, various additional surface treatment may make the powder suitable for its application. For example, the treatments of light resistance, water resistance and weather resistance required in the applications for automotive paints (for example, the methods disclosed in JP-A S63-130,673, JP-A H01-292,067, JP-A H07-268,241, JP-A 2000-505,833, JP-A 2002-194,247, JP-A 2007-138,053), for example, the high orientation (leafing effect) treatment required in the applications for painting and printing (for example, the methods disclosed in JP-A 2001-106,937, JP application H11-347,084), the water-based treatment for water-based paints and water-based printing ink (for example, the methods disclosed in JP-A H8-283,604), dispersibility improvement with silicone and water repellant and oil repellant treatment with hydrogen polysiloxane for the applications of cosmetic products, weld line prevention surface treatments for the applications of resins (for example, those disclosed in JP-A H3-100,068, JP-A H3-93,863), various treatments to improve dispersibility and so on may be carried out. Thus, “transparent electrically conductive powder of the present invention” used herein includes that surface of which have been subjected to above-mentioned various surface treatments.

Similarly, in the above application examples, organic dye, pigment and/or further other electrically conductive materials may be blended. Examples of such materials include carbon black, transparent and opaque white powders, colored and black pigments, and platelet-like iron oxide, organic pigments, hologram pigments, LCPs (liquid crystal polymers) and transparent pigments, colored pigments, metal luster interference pigments and black luster pigments based on conventional mica, metals, glass, and the metal oxide-coated flakes based on Al₂O₃, Fe₂O₃, SiO₂ and glass.

Furthermore, the transparent electrically conductive powder of the present invention may be used as an electrically conductive material for displays replacing ITO, for solar cells, for printing electronic components, for antistatic and for anticounterfeit.

### EXAMPLES

The examples of the present invention will be explained below to illustrate the present invention without limiting it.

In these examples, the TTO layer denotes the layer of tungsten-doped tin oxide, and the PTO layer denotes the layer of phosphorus-doped tin oxide, and the TPTO denotes the layer of tungsten- and phosphorus-doped tin oxide.

In this patent application and in the given examples “elcectrically conductive powder” is defined as follows:

The electrically conductive powder is characterized by its powder resistivity. In this patent application the electrically conductive powders have powder resistivities of less than 10⁶ Ohm*cm, preferrably less than 10⁴ Ohm*cm and most preferably less than 10³ Ohm*cm. These requirements arise from the applications of the conductive pigments in conductive, antistatic or static dissipative coatings, such as, for example, floorings. For instance, surface resitivities permitted for ESD-protected areas are in the range from 10⁴ to 10⁹ Ohm, as described in ESD standards DIN EN 10015 +IEC 61340-5-1 and IEC 61340-5-2 (H. Berndt, Elektrostatik, VDE-Verlag, Berlin, 1998, Chapt. 10). In order to achieve these limits in a formulation containing one or more dielectric binders and a conducting pigment, the power resistivity of the applied conductive pigment, when determined according the above described method, must be at least three orders of ten below the required surface resistivity value of the formulation.

In order to measure the powder resistivity of a pigment powder, an amount of 0.5 -3 g of pigment is placed into an acrylic tube with an inner diameter of 2 cm and compressed in-between two opposing metal plungers by means of a 10 kg weight. By contacting the compressed pigment powder with an ohmmeter via the metal plungers, the electrical resistance is measured. From the thickness L and diameter d of the compressed pigment layer the resistivity p of the pigment is determined according the equation

$$ρ = \frac{R \cdot π \cdot {( \frac{d}{2} )}^{2}}{L} [ Ohm * cm ] .$$

### Reference Example 1

### Preparation of the First Substrate

Method for Manufacturing Titanium-Doped Platelet-Like Aluminum Oxide

Aluminum sulfate octadecahydrate 111.9 g, sodium sulfate (anhydrous) 57.3 g and potassium sulfate 46.9 g are dissolved in 300 ml of deionized water by heating at 60° C. or higher temperature. After dissolving completely, heating is stopped, and titanyl sulfate (concentration: 34.4%) 1.0 g is further added to prepare the mixed aqueous solution (a). Separately, trisodium phosphate dodecahydrate 1.35 g and sodium carbonate 54.0 g are dissolved in 150 ml of deionized water to prepare the mixed aqueous solution (b). The mixed aqueous solution (a) is heated at about 60° C., and the mixed aqueous solution (b) is added to the mixed aqueous solution (a) while stirring to give a gel product and is further stirred for 15 minutes. This gel product is dried to solid and it is further treated with heat at 1,200° C. for 5 hours. Water is added to the resultant treated product and free sulfate salt is dissolved with stirring. Insoluble solid is separated by filtering, washed with water and dried to give a titanium-doped platelet-like aluminum oxide.

### Working Example 1

### Double Layers Coating with TTO to the Mixture of the First Substrate and Second Substrate

91.87 g of titanium-doped platelet-like aluminum oxide obtained by the Reference Example 1 (average particle diameter: 18 μm, average thickness: 220 nm, aspect ratio: 82) and 39.38 g of silicon dioxide particles (FS-3DC from Denki Kagaku Kogyo Co. Ltd., average particle diameter: about 3 μm) are suspended in 1.75 liter of deionized water to give a suspension. The suspension is heated up to 75° C. while being stirred. To coat the first layer of the TTO layer, the pH of the suspension is set at 1.8 with dilute hydrochloric acid. Coating is performed in this suspension by using pre-prepared 141 ml SnCl₄ solution (SnCl₄.5H₂O 74.21 g is dissolved in 105 ml of 18.5%-HCl) and the solution that is prepared by adding 16 wt. % NaOH aqueous solution to 2.16 g of Na₂WO₄.2H₂O until the solution volume becomes 282 ml, while keeping the pH at 1.8 by concurrently adding in drop-wise 16 wt. % NaOH aqueous solution separately. To subsequently coat the second layer of the TTO layer, the pH is set at 2.8 with NaOH aqueous solution. To coat the second layer of the TTO layer, coating is performed by using pre-prepared 422 ml of SnCl₄ solution (SnCl₄.5H₂O 221.11 g is dissolved in 313 ml 18.5%-HCl) and the solution that is prepared by adding 16 wt. % NaOH aqueous solution to 6.46 g of Na₂WO₄.2H₂O until the solution volume becomes 844 ml, while keeping the pH at 2.8 by concurrently adding in drop-wise 16 wt. % NaOH aqueous solution prepared somewhere else.

The resultant suspension is filtered, washed with deionized water, dried at 105° C., and further calcinated in nitrogen atmosphere at 900° C. for 10 minutes to give a transparent electrically conductive powder.

### Working Example 2

Transparent electrically conductive powder is obtained by the manufacture method described in the Working Example 1 except that calcination is performed in the air at 900° C. for 10 minutes.

### Working Example 3

### Double Layers Coating with TTO to the First Substrate and Second Substrate Separately

91.87 g of titanium-doped platelet-like aluminum oxide obtained by Reference Example 1 (average particle diameter: 18 μm, average thickness: 220 nm, aspect ratio: 82) and 39.38 g of silicon dioxide particles (FS-3DC from Denki Kagaku Kogyo Co. Ltd., average particle diameter: about 3 μm) are suspended in 1.75 liter of deionized water to give a suspension. The suspension is heated up to 75° C. while being stirred. To coat the first layer of the TTO layer, the pH of the suspension is set at 1.8 with dilute hydrochloric acid. Coating is performed in this suspension by using pre-prepared 141 ml SnCl₄ solution (SnCl₄.5H₂O 74.21 g is dissolved in 105 ml of 18.5%-HCl) and the solution that is prepared by adding 16 wt. % NaOH aqueous solution to 2.16 g of Na₂WO₄.2H₂O until the solution volume became 282 ml, while keeping the pH at 1.8 by concurrently adding in drop-wise 16 wt. % NaOH aqueous solution separately. To subsequently coat the second layer of the TTO layer, the pH is set at 2.8 with NaOH aqueous solution. To coat the second layer of the TTO layer, coating is performed by using pre-prepared 422 ml of SnCl₄ solution (SnCl₄.5H₂O 221.11 g is dissolved in 313 ml 18.5%-HCl) and the solution that is prepared by adding 16 wt. % NaOH aqueous solution to 6.46 g of Na₂WO₄.2H₂O until the solution volume becomes 844 ml, while keeping the pH at 2.8 by concurrently adding in drop-wise 16 wt. % NaOH aqueous solution prepared somewhere else.

On the other hand, the dried powder B is similarly obtained by using silicon dioxide particles (FS-3DC from Denki Kagaku Kogyo Ltd., average particle diameter: about 3 μm) in place of titanium-doped platelet-like aluminum oxide in the above manufacture method.

The resultant dried powders A and B are blended in the weight ratio of 6:, and then calcinated in nitrogen atmosphere at 900° C. for 10 minutes to give a transparent electrically conductive powder.

### Working Example 4

Transparent electrically conductive powder is obtained by the manufacture method described in the Working Example 3 except that calcination is performed in the air at 900° C. for 10 minutes.

### Working Example 5

### Double Layers Coating with TTO of the First Substrate

131.25 g of titanium-doped platelet-like aluminum oxide obtained by the reference example 1 (average particle diameter: 18 μm, average thickness: 220 nm, aspect ratio: 82) is suspended in 1.75 liter of deionized water to give a suspension. The suspension is heated up to 75° C. while being stirred. To coat the first layer of the TTO layer, the pH of the suspension is set at 1.8 with dilute hydrochloric acid. Coating is performed in this suspension by using pre-prepared 141 ml of SnCl₄ solution (SnCl₄.5H₂O 74.21 g is dissolved in 105 ml 18.5%-HCl) and the solution that is prepared by adding 16 wt. % NaOH aqueous solution to 2.16 g of Na₂WO₄.2H₂O until the solution volume becomes 282 ml, while keeping the pH at 1.8 by concurrently adding in drop-wise 16 wt. % NaOH aqueous solution prepared separately. To subsequently coat the second layer of the TTO layer, the pH is set at 2.8 with NaOH aqueous solution. To coat the second layer of the TTO layer, coating is performed by using pre-prepared 422 ml of SnCl₄ solution (SnCl₄.5H₂O 221.11 g is dissolved in 313 ml 18.5%-HCl) and the solution that is prepared by adding 16 wt. % NaOH aqueous solution to 6.46 g of Na₂WO₄.2H₂O until the solution volume becomes 844 ml, while keeping the pH at 2.8 by concurrently adding in drop-wise 16 wt. % NaOH aqueous solution prepared separately.

The resultant suspension is filtered, washed with deionized water, dried at 105° C., and further calcinated in nitrogen atmosphere at 900° C. for 10 minutes to give transparent electrically conductive powder.

### Working Example 6

Transparent electrically conductive powder is obtained by the manufacture method described in the Working Example 5 except that calcination is performed in the air at 900° C. for 10 minutes.

### Reference Powder Example 1

### Double Layers Coating with TTO of the Second Substrate

131.25 g of silicon dioxide particle (FS-3DC from Denki Kagaku Kogyo Ltd., average particle diameter: about 3 μm) is suspended in 1.75 liter of deionized water to give a suspension. The suspension is heated up to 75° C. while being stirred. To coat the TTO layer of the first layer, the pH of the suspension is set at 1.8 with dilute hydrochloric acid. Coating is performed in this suspension by using pre-prepared 141 ml of SnCl₄ solution (SnCl₄.5H₂O 74.21 g is dissolved in 105 ml 18.5%-HCl) and the solution that is prepared by adding 16 wt. % NaOH aqueous solution to 2.16 g of Na₂WO₄.2H₂O until the solution volume becomes 282 ml, while keeping the pH at 1.8 by concurrently adding in drop-wise 16 wt. % NaOH aqueous solution prepared separately. To subsequently coat the second layer of the TTO layer, the pH is set at 2.8 with NaOH aqueous solution. To coat the second layer of the TTO layer, coating is performed by using pre-prepared 422 ml of SnCl₄ solution (SnCl₄.5H₂O 221.11 g is dissolved in 313 ml 18.5%-HCl) and the solution that is prepared by adding 16 wt. % NaOH aqueous solution to 6.46 g of Na₂WO₄.2H₂O until the solution volume becomes 844 ml, while keeping the pH at 2.8 by concurrently adding in drop-wise 16 wt. % NaOH aqueous solution prepared somewhere else.

The resultant suspension is filtered, washed with deionized water, dried at 105° C., and further calcinated in nitrogen atmosphere at 900° C. for 10 minutes to give a transparent electrically conductive powder.

### Reference Powder Example 2

Transparent electrically conductive powder is obtained by the manufacture method described in the Reference Powder Example 1 except that calcination is performed in the air at 900° C. for 10 minutes.

### Reference Example 2

### Manufacture of Un-Doped Al₂O₃ Substrate

Aluminum sulfate octadecahydrate 111.9 g, sodium sulfate (anhydrous) 57.3 g and potassium sulfate 46.9 g are dissolved in 300 ml of deionized water while heating at 60° C. or higher temperature. After dissolving completely, heating is stopped, and the mixed aqueous solution (a) is prepared. Separately, trisodium phosphate dodecahydrate 1.35 g and sodium carbonate 54.0 g are dissolved in 150 ml of deionised water to prepare the mixed aqueous solution (b). The mixed aqueous solution (a) is heated at about 60° C., and the mixed aqueous solution (b) is added to the mixed aqueous solution (a) while stirring to give a gel product and is further stirred for 15 minutes. This gel product is dried to solid and it is treated with heat at 1,200° C. for 5 hours. Water is added to the resultant treated product and free sulfate salt is dissolved with stirring. Insoluble solid is separated by filtering, washed with water and dried to give an un-doped platelet-like aluminum oxide.

### Working Example 7a

Transparent electrically conductive powder is obtained by the manufacture method described in the Working Example 5 except that the un-doped platelet-like aluminum oxide obtained by the Reference Example 2 is used as a substrate in place of titanium-doped platelet-like aluminum oxide.

### Working Example 7b

Transparent electrically conductive powder is obtained by the manufacture method described in the Working Example 6 except that the un-doped platelet-like aluminum oxide obtained by the Reference Example 2 is used as a substrate in place of titanium-doped platelet-like aluminum oxide.

### Comparative Example 1

White electrically conductive powder is obtained by the manufacture method described in the Working Example 5 except that rutile-type titanium dioxide (KR-310 from Titan Kogyo Co., Ltd.) is used as a substrate in place of titanium-doped platelet-like aluminum oxide.

### Comparative Example 2

### Single Layer Coating with 1.8 of pH for TTO of the First Substrate

131.25 g of titanium-doped platelet-like aluminum oxide (average particle diameter: 18 μm, average thickness: 220 nm, aspect ratio: 82) is suspended in 1.75 liter of deionized water to give a suspension. The suspension is heated up to 75° C. while being stirred. To coat the TTO layer, the pH of the suspension is set at 1.8 with dilute hydrochloric acid. Coating is performed in this suspension by using pre-prepared 563 ml of SnCl₄ solution (SnCl₄.5H₂O of 295.32 g is dissolved in 18.5%-HCl of 418 ml) and the solution that is prepared by adding 16 wt. % NaOH aqueous solution to 8.62 g of Na₂WO₄.2H₂O until the solution volume becomes 1126 ml, while keeping the pH at 1.8 by concurrently adding in drop-wise 16 wt. % NaOH aqueous solution prepared separately.

The resultant suspension is filtered, washed with deionized water, dried at 105° C., and further calcinated in nitrogen atmosphere at 900° C. for 10 minutes to give transparent electrically conductive powder. It is confirmed by SEM image that the obtained powder has cracks on its surface (FIG. 2).

### Comparative Example 3

### Single Layer Coating with 2.8 of pH for TTO of the First Substrate

131.25 g of titanium-doped platelet-like aluminum oxide obtained by Reference Example 1 (average particle diameter: 18 μm, average thickness: 220 nm, aspect ratio: 82) is suspended in 1.75 liter of deionized water to give a suspension. The suspension is heated up to 75° C. while be stirred. To coat the TTO layer, the pH of the suspension is set at 2.8 with dilute hydrochloric acid. Coating is performed in this suspension by using pre-prepared 563 ml of SnCl₄ solution (SnCl₄.5H₂O of 295.32 g is dissolved in 18.5%-HCl of 418 ml) and the solution that is prepared by adding 16 wt. % NaOH aqueous solution to 8.62 g Na₂WO₄.2H₂O until the solution volume becomes 1126 ml, while keeping the pH at 2.8 by concurrently adding in drop-wise 16 wt. % NaOH aqueous solution prepared separately.

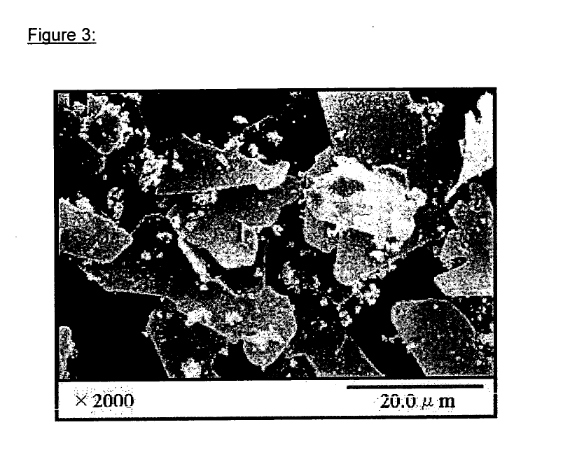

The resultant suspension is filtered, washed with deionized water, dried at 105° C., and further calcinated in nitrogen atmosphere at 900° C. for 10 minutes to give transparent electrically conductive powder. It is confirmed by SEM image that the obtained powder has non-coating particles on its surface (FIG. 3).

### Working Example 8

Transparent electrically conductive powder is obtained by the manufacture method as described in Working Example 5 except that the pH to coat the second layer of the TTO layer is 3.0.

### Working Example 9

Transparent electrically conductive powder is obtained by the manufacture method as described in Working Example 5 except that the pH to coat the second layer of the TTO layer is 3.2.

### Working Example 10

Transparent electrically conductive powder is obtained by the manufacture method as described in Working Example 5 except that the pH to coat the second layer of the TTO layer is 3.5.

### Comparative Example 4

Transparent electrically conductive powder is obtained by the manufacture method as described in Working Example 5 except that the pH to coat the second layer of the TTO layer is 4.0.

### Working Example 11

### Double Layers Coating with TPTO of the First Substrate

131.25 g of titanium-doped platelet-like aluminum oxide obtained by the Reference Example 1 (average particle diameter: 18 μm, average thickness: 220 nm, aspect ratio: 82) is suspended in 1.75 liter of deionized water to give a suspension. The suspension is heated up to 75° C. while be stirred. To coat the first layer of the TPTO layer, the pH of the suspension is set at 1.8 with dilute hydrochloric acid. Coating is performed in this suspension by using 141 ml of pre-prepared SnCl₄ solution (SnCl₄.5H₂O of 74.21 g is dissolved in 18.5%-HCl of 105 ml) which is added with 85% orthophosphoric acid aqueous solution (1.23 g), and the solution that is prepared by adding 16 wt. % NaOH aqueous solution to 2.16 g of Na₂WO₄.2H₂O until the solution volume becomes 282 ml, while keeping the pH at 1.8 by concurrently adding in drop-wise 16 wt. % NaOH aqueous solution prepared separately to coat TPTO layer. To subsequently coat the second layer of the TPTO layer, the pH is set at 2.8 with NaOH aqueous solution. To coat the second layer of the TPTO layer, coating is performed by using 422 ml of pre-prepared SnCl₄ solution (SnCl₄.5H₂O of 221.11 g is dissolved in 18.5%-HCl of 313 ml) which is added with 85% orthophosphoric acid aqueous solution (3.63 g), and the solution that is prepared by adding 16 wt. % NaOH aqueous solution to 6.46 g of Na₂WO₄.2H₂O until the solution volume becomes 844 ml, while keeping the pH at 2.8 by concurrently adding in drop-wise 16 wt. % NaOH aqueous solution prepared separately.

The resultant suspension is filtered, washed with deionized water, dried at 105° C., and further calcinated in nitrogen atmosphere at 900° C. for 10 minutes to give transparent electrically conductive powder.

### Working Example 12

Transparent electrically conductive powder is obtained by the manufacture method as described in the working example 11 except that calcination is performed in the air at 900° C. for 10 minutes.

### Working Example 13

### Double Layers Coating only PTO Layer on the First Substrate

131.25 g of titanium-doped platelet-like aluminum oxide obtained by the reference example 1 (average particle diameter: 18 μm, average thickness: 220 nm, aspect ratio: 82) is suspended in 1.75 liter of deionized water to give a suspension. The suspension is heated up to 75° C. while be stirred. To coat the first layer of the PTO layer, the pH of the suspension is set at 1.8 with dilute hydrochloric acid. Coating is performed in this suspension by using 141 ml of pre-prepared SnCl₄ solution (SnCl₄.5H₂O 74.21 g is dissolved in 105 ml 18.5%-HCl) which is added with 85% orthophosphoric acid aqueous solution (1.23 g) while keeping the pH at 1.8 by concurrently adding in drop-wise 32 wt. % NaOH aqueous solution prepared separately to coat PTO layer. To subsequently coat the second layer of the PTO layer, the pH is set at 2.8 with NaOH aqueous solution. To coat the second layer of the PTO layer, coating is performed by using 422 ml of pre-prepared SnCl₄ solution (SnCl₄.5H₂O 221.11 g is dissolved in 313 ml 18.5%-HCl) which is added with 85% orthophosphoric acid aqueous solution (3.63 g) while keeping the pH at 2.8 by concurrently adding in drop-wise 32 wt. % NaOH aqueous solution prepared separately.

The resultant suspension is filtered, washed with deionized water, dried at 105° C., and further calcinated in nitrogen atmosphere at 900° C. for 10 minutes to give a transparent electrically conductive powder.

### Comparative Example 5

Transparent electrically conductive powder is obtained by the manufacture method as described in Working Example 13 except that calcination is performed in the air at 900° C. for 10 minutes.

Tables 1 to 4 show the layer constitutions, calcination conditions and measurement results of the above given examples. The measurement is carried out by the following methods.

Method for Measuring “Powder Volume Resistance: Rv (Ωcm)”:

The resultant powder is pressed by a section area of 1 cm² with pressure of 10 kg/cm², and the electrical resistance (R) of the powder is measured by a resistance meter (R8340 from Advantest Co.). Then, the thickness (t) of the pressed powder is measured and the Rv is calculated by the following formula:

Rv=R×S/t(Ωcm).

Method for Measuring “Surface Resistance Rs (Ω)”:

Method for making an evaluation coated board

1. Method for Preparing Paint
Acrylic lacquer formulated in a certain concentration (Planet from Origin ELECTRIC Co., Ltd.) and the obtained sample are blended by hands. After blending for 2 minutes by a mixer, the mixture is diluted with thinner. The viscosity of the prepared paint is 12.5 sec by the method of Ford Cup #4.

2. Condition of Coating
Coating is performed on a plastic plate (ABS resin) by a spray gun (W-100 from Iwata Co.) and drying is performed at 60° C. for 20 minutes. After drying, the thickness of coating film is 20 μm to 30 μm.

3. Method for Measuring
Measuring voltage is set at 500 V for a resistance meter (R8340 from Advantest Co.), and Rs is measured according to JIS K 6911, 5.13 method for measuring resistivity.

Method for Measuring “Transparency”:

The resultant sample is suspended in paint (VS medium from Dainichiseika Color & Chemicals Mfg. Co.) as PWC by the concentration of 30 wt. %, and then is coated on a PET film (Lumirror S10 from Toray Industries Inc., 50 μm in thickness, 86% in all-optical transmittance) by using a bar-coater (#20) and dried at room temperature. The thickness of the coated film is 8 μm. By using a hazy meter (HM-150 from Murakami Color Research Laboratory), the all-optical transmittance of the film is measured by JIS K-7361.

Method for Measuring “Powder pH”:

The pH of the resultant sample is measured by the method stipulated by JIS K5101-17-2.

Long-Term Stability Test

As an accelerated test of powder volume resistance (Rv), the prepared transparent electrically conductive powder is left at 100° C. for 2 hours, and its Rv is measured before and after the accelerated test.

Throughout the entire description, “TTO” denotes “tungsten-doped tin oxide”, “TPTO” denotes “tungsten- and phosphorus-doped tin oxide”, and “PTO” denotes “phosphorus-doped tin oxide.”

TABLE 1
Examples of TTO Coating

| | Coating | | Calcination | Total-opt. | Rv | Rs (MΩ) | Rs (MΩ) |
|---|---|---|---|---|---|---|---|
| | layer | Substrate | Atmosphere | Trans. (%) | (Ωcm) | PWC = 30% | PWC = 40% |
| Working | TTO | Ti—Al₂O₃:SiO₂ = 7:3 | Nitrogen | 78 | 32 | 0.4 | 0.1 |
| Example 1 | | | | | | | |
| Working | TTO | Ti—Al₂O₃:SiO₂ = 7:3 | Air | 78 | 210 | 2 | 0.9 |
| Example 2 | | | | | | | |
| Working | TTO | Ti—Al₂O₃:SiO₂ = 6:4 | Nitrogen | 78 | 24 | 0.7 | 0.1 |
| Example 3 | | | | | | | |
| Working | TTO | Ti—Al₂O₃:SiO₂ = 6:4 | Air | 78 | 190 | 4 | 1 |
| Example 4 | | | | | | | |
| Working | TTO | Ti—Al₂O₃ | Nitrogen | 82 | 20 | 3 | 0.2 |
| Example 5 | | | | | | | |
| Working | TTO | Ti—Al₂O₃ | Air | 82 | 250 | 20 | 8 |
| Example 6 | | | | | | | |
| Reference | TTO | SiO₂ | Nitrogen | 78 | 24 | 100 or | |
| Powder | | | | | | more | |
| Example 1 | | | | | | | |
| Reference | TTO | SiO₂ | Air | 79 | 200 | 100 or | |
| Powder | | | | | | more | |
| Example 2 | | | | | | | |
| Working | TTO | Al₂O₃ | Nitrogen | 81 | 20 | 10 | |
| Example 7a | | | | | | | |
| Working | TTO | Al₂O₃ | Air | 82 | 250 | 100 | 8 |
| Example 7b | | | | | | | |
| Comp. | TTO | TiO₂ | Nitrogen | 54 | 2.9M | 100 or | 100 or |
| Example 1 | | | | | | more | more |

In the table, TTO represents a tungsten-doped tin oxide, Ti—Al₂O₃ denotes a titanium-doped platelet-like aluminum oxide, and Al₂O₃ denotes an un-doped platelet-like aluminum oxide.

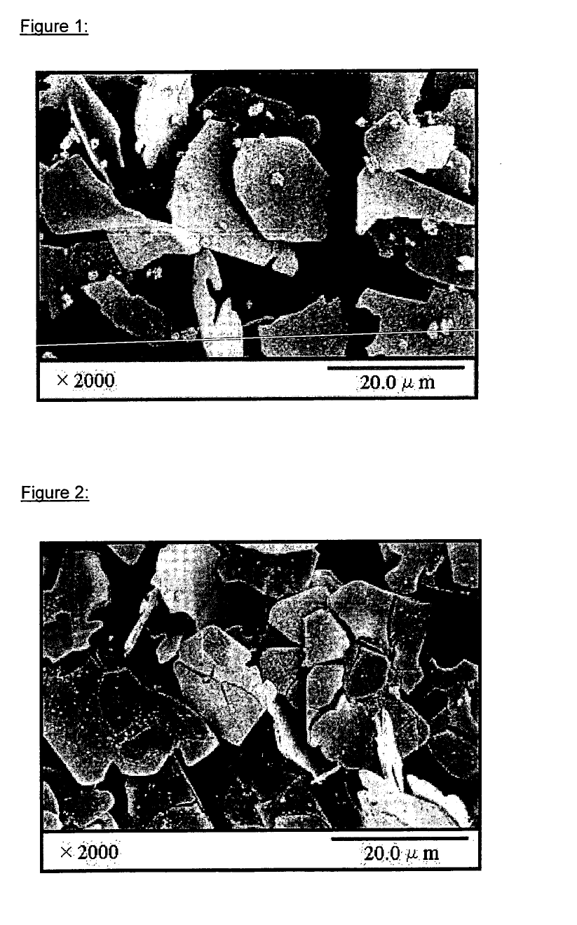

TABLE 2
SEM Image by TTO Coating Condition

| | Coating Layer | Substrate | SEM image |
|---|---|---|---|
| Working | TTO | Ti—Al₂O₃ | FIG. 1 |
| Example 5 | | | |
| Comp. | TTO | Ti—Al₂O₃ | FIG. 2: Cracks on |
| Example 2 | | | surface is observed. |
| Comp. | TTO | Ti—Al₂O₃ | FIG. 3: Deposition of |
| Example 3 | | | non-coating particles |
| | | | is observed. |

TABLE 3
Two-steps of pH during TTO Coating

| | | | Coating pH | pH of | |
|---|---|---|---|---|---|
| | Coating | | First- | powder | Rv |
| | layer | Substrate | Second | obtained | (Ωcm) |
| Working | TTO | Ti—Al₂O₃ | 1.8-2.8 | 3.96 | 20 |
| Example 5 | | | | | |
| Working | TTO | Ti—Al₂O₃ | 1.8-3.0 | 4.03 | 28 |
| Example 8 | | | | | |
| Working | TTO | Ti—Al₂O₃ | 1.8-3.2 | 5.91 | 30 |
| Example 9 | | | | | |
| Working | TTO | Ti—Al₂O₃ | 1.8-3.5 | 7.67 | 130 |
| Example 10 | | | | | |
| Comp. | TTO | Ti—Al₂O₃ | 1.8-4.0 | 10.16 | 30000 |
| Example 4 | | | | | |

TABLE 4
TTO Coating and TPTO Coating

| | | | | Rv before | Rv after |
|---|---|---|---|---|---|
| | | | | accel- | accel- |
| | Coating | | Calcination | erated | erated |
| | Layer | Substrate | atmosphere | test (Ωcm) | test (Ωcm) |
| Working | TTO | Ti—Al₂O₃ | Nitrogen | 20 | 20 |
| Example 5 | | | | | |
| Working | TTO | Ti—Al₂O₃ | Air | 250 | 280 |
| Example 6 | | | | | |
| Working | TPTO | Ti—Al₂O₃ | Nitrogen | 28 | 26 |
| Example 11 | | | | | |
| Working | TPTO | Ti—Al₂O₃ | Air | 240 | 200 |
| Example 12 | | | | | |
| Working | PTO | Ti—Al₂O₃ | Nitrogen | 28 | 35 |
| Example 13 | | | | | |
| Comparative | PTO | Ti—Al₂O₃ | Air | 900 | 2700 |
| Example 5 | | | | | |

1. A transparent electrically conductive powder, comprising a first powder component that comprises
(a) a doped or undoped platelet-like aluminum oxide as a first substrate, and
(b) a coating layer containing at least any one of tungsten-doped tin oxide or phosphorous-doped tin oxide and coating the surface of the first substrate.

2. A transparent electrically conductive powder according to claim 1, comprising a first powder component that comprises
(a) a doped or undoped platelet-like aluminum oxide as a first substrate; and
(b) a coating layer containing tungsten-doped tin oxide (hereafter, referred as TTO) and coating the surface of the first substrate.

3. The transparent electrically conductive powder according to claim 1, characterized in that the platelet-like aluminum oxide is doped with a metal element.

4. The transparent electrically conductive powder according to claim 1, characterized in that the platelet-like aluminum oxide has a refractive index of 2 or less.

5. The transparent electrically conductive powder according to claim 1, characterized in that the coating layer (b) comprises tungsten- and phosphorus-doped tin oxide (hereafter, referred as TPTO).

6. The transparent electrically conductive powder according to claim 1, characterized in that the coating layer (b) comprises phosphorus-doped tin oxide (hereafter, referred as PTO).

7. The transparent electrically conductive powder according to claim 1, characterized in that the size of the first substrate is 1 to 100 μm in an average particle diameter.

8. The transparent electrically conductive powder according to claim 1, characterized in that the first substrate has a thickness of not more than 1 μm.

9. The transparent electrically conductive powder according to claim 1, characterized in that the first substrate has an aspect ratio of not less then 5, wherein the aspect ratio is defined as the following equation: the average particle diameter/the thickness.

10. The transparent electrically conductive powder according to claim 1, characterized in that the metal element doping the first substrate is at least one selected from the group consisting of titanium and tin.

11. The transparent electrically conductive powder according to claim 1, characterized in that the first substrate is in a form of a monocrystal.

12. The transparent electrically conductive powder according to claim 1, further comprising a second powder component that comprises:
(a) an inorganic particle as a second substrate; and
(b) a coating layer containing TTO or TPTO or PTO and coating the surface of the second substrate.

13. The transparent electrically conductive powder according to claim 12, characterized in that the second substrate is a silicon dioxide particle and/or an aluminum oxide particle.

14. The transparent electrically conductive powder according to claim 12, characterized in that the mixture ratio by weight of the first powder component and the second powder component is 9:1 to 2:8.

15. The transparent electrically conductive powder according to claim 1, characterized in that the amount of the coating layer in the first powder is 25 to 300 parts by weight as the oxides based on 100 parts by weight of the first substrate.

16. The transparent electrically conductive powder according to claim 12, characterized in that the amount of the coating layer in the second powder is 25 to 300 parts by weight as the oxides based on 100 parts by weight of the second substrate.

17. The transparent electrically conductive powder according to claim 1, characterized in that the coating layer of the first powder comprises at least two layers, and a top surface layer is the coating layer containing the TTO, or the coating layer containing the TPTO, or the coating layer containing the PTO.

18. The transparent electrically conductive powder according to claim 12, characterized in that the coating layer of the second powder comprises at least two layers, and a top surface layer is the coating layer containing the TTO, or the coating layer containing the TPTO, or the coating layer containing the PTO.

19. The transparent electrically conductive powder according to claim 1, characterized in that the coating layer of the first powder comprises a first coating layer and a second coating layer as a top surface layer, wherein the second coating layer is a coating layer containing the TTO, or a coating layer containing the TPTO, or the coating layer containing the PTO, and weight ratio of amount of coating of the first coating layer and the second coating layer is in the range of 5:95 to 60:40 as the oxides.

20. The transparent electrically conductive powder according to claim 12, characterized in that the coating layer of the second powder comprises a first coating layer and a second coating layer as a top surface layer, wherein the second coating layer is a coating layer containing the TTO, or a coating layer containing the TPTO, or the coating layer containing the PTO, and weight ratio of amount of coating of the first coating layer and the second coating layer is in the range of 5:95 to 60:40 as the oxides.

21. The transparent electrically conductive powder according to claim 1, characterized in that the total optical transmittance of a film with 8 μm in a thickness containing 30 wt. % powder concentration of the transparent electrically conductive powder within a resin is not less than 70%.

22. The transparent electrically conductive powder according to claim 1, characterized in that the first powder component has a pH of 1.5 to 8 according to measurement under JIS K5101-17-2.

23. The transparent electrically conductive powder according to claim 1, characterized in that the coating layer of the first powder comprises a first coating layer containing at least tin oxide and a second coating layer containing TTO or TPTO or PTO, and wherein the first coating layer and the second coating layer have been formed under different pH conditions, and the second coating layer has been formed under in the range of pH 2.2 to 3.5.

24. The transparent electrically conductive powder according to claim 12, characterized in that the coating layer of the second powder comprises a first coating layer containing at least tin oxide and a second coating layer containing TTO or TPTO or PTO, and wherein the first coating layer and the second coating layer have been formed under different pH conditions, and the second coating layer has been formed under in the range of pH 2.2 to 3.5.

25. A method for manufacturing a transparent electrically conductive powder according to claim 1, comprising steps of:
(a) suspending within water a doped or undoped platelet-like aluminum oxide as a first substrate, and/or a substrate of an inorganic particle which is not identical with the first substrate as a second substrate;
(b) adding an aqueous solution of a tin compound to the suspension to form a first coating layer; and
(c) after the first coating layer has been formed, either
(1) adding an aqueous solution of a tin compound and an aqueous solution of a tungsten compound, or
(2) adding an aqueous solution of a tin compound, an aqueous solution of a tungsten compound and an aqueous solution of a phosphorus compound, or
(3) adding an aqueous solution of a tin compound and an aqueous solution of a phosphorous compound,
thereby forming a second coating layer.

26. The method according to claim 25, wherein the tin compound is at least one selected from tin salts.

27. The method according to claim 25, wherein the pH is adjusted with an alkaline aqueous solution during the formation of the first coating layer and the formation of the second coating layer.

28. A resin composition, comprising the transparent electrically conductive powder according to claim 1 that is blended in a resin.

29. A paint, primer, ink, plastic, rubber, or lacquer comprising the transparent electrically conductive powder according to claim 1.

30. A transparent electrically conductive primer, comprising the transparent electrically conductive powder according to claim 1.

31. A coated film formed by applying a paint comprising the transparent electrically conductive powder according to claim 1.
